(19) United States
(12) Patent Application Publication
(10) Pub. No.: US 2010/0241666 A1
(43) Pub. Date: Sep. 23, 2010

(54) MUSIC CONCEPTUAL DATA PROCESSING METHOD, VIDEO DISPLAY DEVICE, AND MUSIC CONCEPTUAL DATA PROCESSING SERVER

(76) Inventor: Takahisa Kaihotsu, Musashino-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/713,005

(22) Filed: Feb. 25, 2010

(30) Foreign Application Priority Data
Mar. 18, 2009 (JP) 2009-066648

(51) Int. Cl. G06F 17/30; G06F 15/16

(52) U.S. Cl. 707/780; 707/E17.009; 707/E17.01; 709/203; 707/827

(57) ABSTRACT

According to one embodiment, an embodiment of the present invention has following elements. A data file stores a plurality of pieces of destination information and a plurality of pieces of lexicon classification node information. The destination information indicates a region where a video is provided, and the lexicon classification node information indicates a concept of a music composition and is associated with one or more of the plurality of pieces of destination information. A retrieval module (a) retrieves proper lexicon classification node information to music composition concept, (b) extracts hit destination information corresponding to the retrieved lexicon classification node information, (c) executes the retrieval a plurality of times by changing the music composition concept and acquire proper hit destination information, and (d) outputs the proper hit destination information for acquisition of a video of a corresponding destination.

### CROSS-REFERENCE TO RELATED APPLICATIONS

This application is based upon and claims the benefit of priority from Japanese Patent Application No. 2009-066648, filed Mar. 18, 2009, the entire contents of which are incorporated herein by reference.

### BACKGROUND

1. Field

One embodiment of the invention relates to a data processing method, a video display device, and a processing server, capable of associating music concept or impressions with regional videos.

2. Description of the Related Art

There is disclosed a technique of acquiring information on sites on networks, content on content servers, and live videos from live cameras by inputting departure and destination points via user terminal devices. This system allows a user to browse content, such as images displayed on display modules, and experience simulated travel that would take the user on a journey while staying at home. (See Jpn. Pat. Appln. KOKAI Publication No. 2007-156562.)

Further, in some karaoke systems, music composition data is categorized by genre, and live cameras connected to networks are placed in a plurality of locations after being categorized by genre (see Jpn. Pat. Appln. KOKAI Publication No. 2002-297167). In such karaoke systems, when a customer selects a music composition, a live camera video matching the music composition is transmitted. The transmitted video is displayed as a video for karaoke in the background of a display module.

### BRIEF DESCRIPTION OF THE SEVERAL VIEWS OF THE DRAWINGS

A general architecture that implements the various feature of the invention will now be descried with reference to the drawings. The drawings and the associated descriptions are provided to illustrate embodiments of the invention and not to limit the scope of the invention.

FIG. 1 is a block diagram illustrating a device according to an embodiment of the present invention;

FIG. 2 is an exemplary diagram illustrating a music data management table used in the present invention;

FIG. 3 is an exemplary diagram illustrating a live camera management table used in the present invention;

FIG. 4 is an exemplary diagram illustrating a conceptual graph used in the present invention;

FIG. 5 is an exemplary diagram illustrating a data structure of a conceptual graph used in the present invention;

FIGS. 6A and 6B are exemplary diagrams illustrating GUI for live camera display setting and a remote control, respectively, used in the present invention;

FIGS. 7A and 7B are exemplary diagrams illustrating a music composition selection screen and a remote control, respectively, used in the present invention;

FIG. 8 is an exemplary flowchart for generating a live camera management table used in the present invention;

FIG. 9 is an exemplary flowchart for retrieving a conceptual graph used in the present invention;

FIG. 10 is an exemplary diagram illustrating a conceptual graph by genre;

FIG. 11 illustrates Retrieval Example 1 of a conceptual graph by keyword;

FIG. 12 illustrates Retrieval Example 2 of a conceptual graph by keyword;

FIG. 13 illustrates Storage Example 1 of data in a live camera management table;

FIG. 14 illustrates Storage Example 2 of data in a live camera management table;

FIG. 15 is an exemplary diagram of a completed live camera management table;

FIG. 16 is an exemplary flowchart of live camera display;

FIG. 17 is an exemplary diagram illustrating a usage scene in which the device of the present invention is used; and

FIG. 18 is a block diagram illustrating a server configuration according to another embodiment of the present invention.

### DETAILED DESCRIPTION

Various embodiments according to the invention will be described hereinafter with reference to the accompanying drawings.

First, the background of the present invention will be described.

When music and live videos are associated, there is a demand that music and live videos should be acquired correctly. Further, there is also a demand that music and live images should not be fixedly associated, can be automatically updated and modified, and should be executed with flexibility.

It is therefore an object of an embodiment of the present invention to provide a music conceptual data processing method, a video display device, and a music conceptual data processing server capable of closely associating music concept or impressions with regional videos.

In order to achieve the above-described object, an embodiment of the present invention comprises a data file and a retrieval module.

The data file stores data on a conceptual graph. The data on the conceptual graph contains a plurality of pieces of destination information each indicating a region where a video is provided, and a plurality of pieces of lexicon classification node information each associated with one or more of said plurality of pieces of destination information items and each indicating a concept of a music composition.

The retrieval module (a) retrieves, upon receipt of information on a music composition to be played back, lexicon classification node information similar to or same as music composition concept information indicating a concept of the received music composition from said plurality of pieces of lexicon classification node information, (b) extract hit destination information corresponding to the retrieved lexicon classification node information from said plurality of pieces of destination information, (c) execute the retrieval a plurality of times by changing the music composition conceptual information, and (d) retrieve one or more pieces of hit destination information strongly associated with the selected music composition.

Said one or more pieces of hit destination information is used for acquisition of a video of a corresponding destination.

The above-described process enables the present invention to provide an advantageous effect of closely associating music concept or impressions with regional videos.

Further descriptions will be given below.

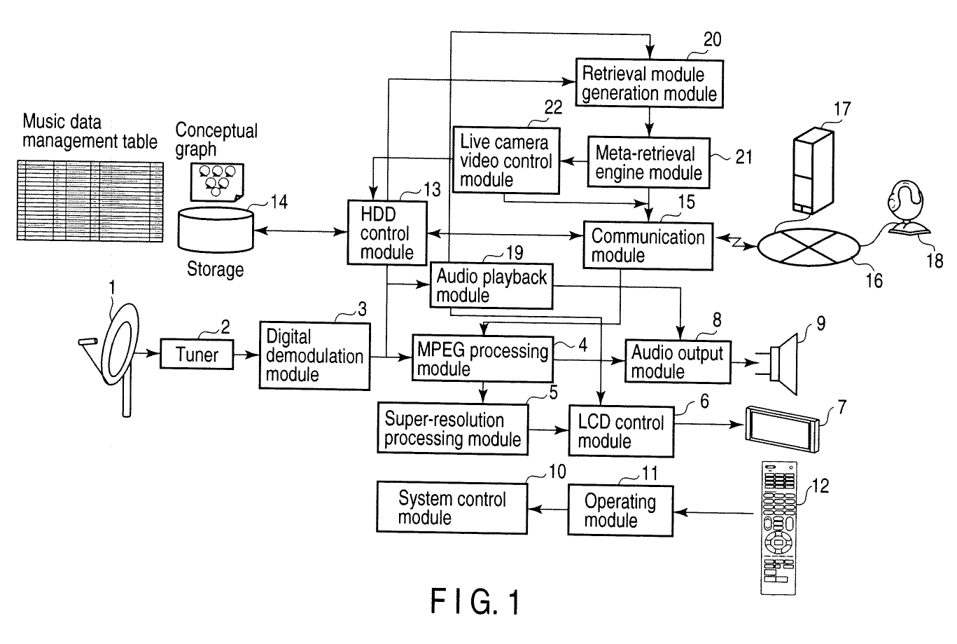

FIG. 1 is an exemplary structure of a video display device, to which the present invention is applied. An antenna 1 is connected to a tuner 2, and receives terrestrial digital broadcasts. The tuner 2 is designed to receive television broadcasts and select channels. In the present embodiment, the tuner 2 functions as a device for receiving digital broadcasts and temporarily converting signals of received channels into intermediate frequency (IF) signals. A digital demodulation module 3 fetches digital signals (transport streams (TS)) from the IF signals and transmit them to an MPEG processing module 4. The MPEG processing module 4 processes the transport stream transmitted from the digital demodulation module 3 or a communication module 15, and decodes the videos/audios. The decoded video data is supplied to a liquid crystal display (LCD) control module 6. The audio data is supplied to an audio output module 7 and is played back.

A super-resolution processing module 5 is connected to the MPEG processing module 4, and is designed to reconstruct signals lost in the digitalization process and increase resolution of videos by increasing pixels of the videos. Generally, the super-resolution processing module 5 is used to upconvert the 1440×1080 resolution of terrestrial digital broadcasts into the 1920×1080 resolution of full high-definition (HD) images. Further, in the present embodiment, the super-resolution processing module 5 is used to convert the image quality of live camera videos that is greatly inferior to the resolution of television broadcast into the full-HD image quality.

The LCD control module 6 is connected to the super-resolution processing module 5 and transmits video data to a liquid crystal display 7 (hereinafter simply referred to as LCD 7), where images are displayed.

The LCD 7 is connected to the LCD control module 6, and displays video data decoded by the MPEG processing module 4 and upconverted by the super-resolution processing module 5. That is, the LCD 7 is a display for displaying programs of digital terrestrial broadcasts and live camera videos.

The audio output 8 is connected to a speaker 9, and outputs audio data output from the MPEG processing module 4 and a audio playback module 19. That is, the audio output module 8 outputs audios of a terrestrial digital broadcasts or music compositions when audios are played back. The speaker 9 is connected to the audio output module 8, and outputs audios or music compositions.

The system control module 10 is a processing module for performing overall control of the operation of the processing modules of the present invention. The control module 10 comprises, although not shown, a ROM for storing control programs, a RAM needed as a work area in a process that will be described below, and a nonvolatile memory (flash memory) that stores live camera setting and the like.

An operating module 11 receives a control command from a remote control (hereinafter simply referred to as remote) 12, and transmits the control command to the system control module 10. The remote 12 is a device for operating the device of the present invention, and provides the operation module 11 with a control command via infrared wireless communications. The remote 12 is provided with a numerical pad for inputting numbers, and allows input of channel numbers. The remote 12 is further provided with a D-pad, which allows graphical user interface (GUI) operations, such as selection of music composition lists and selection of setting items.

In the present embodiment, the remote 12 is used for system settings, such as whether to switch live camera videos on or off, and specification of automatic switching intervals of live camera videos, and for selection of albums and music compositions when music is played back.

The HDD control module 13 is connected to a storage 14, and controls reading and writing of data in the storage 14 (video data, music data, and system data). The storage 14 is a hard disc drive (HDD). The storage 14 stores MPEG-format video data, MP3-format music data, and system data, for example.

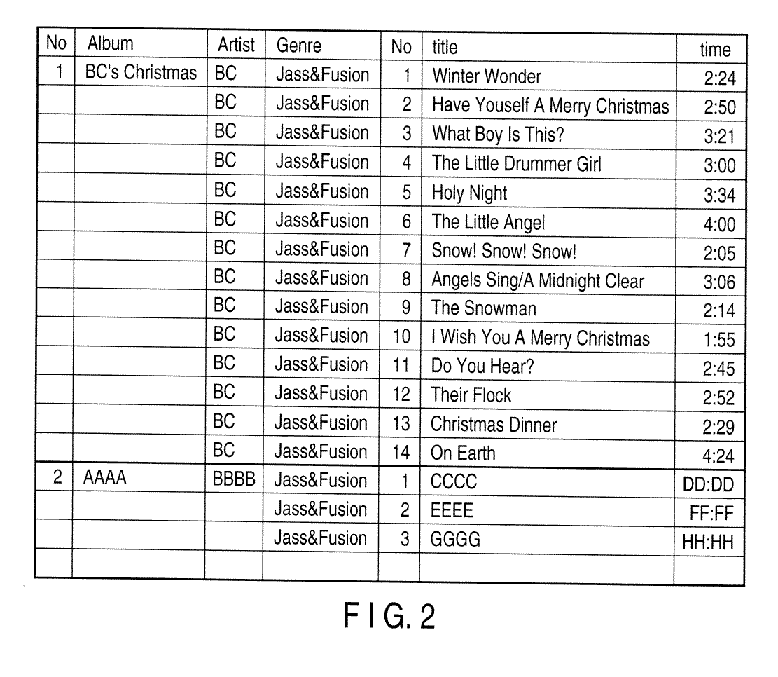

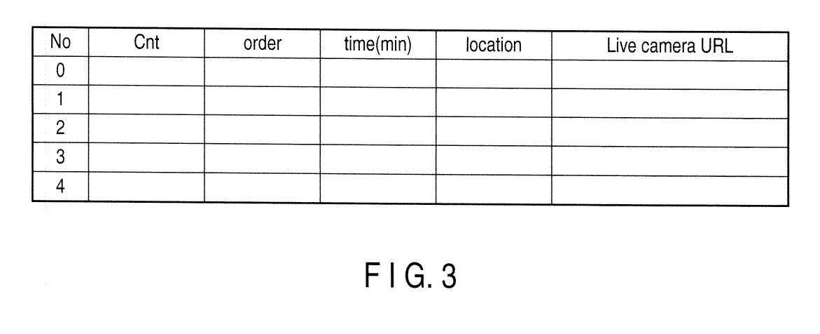

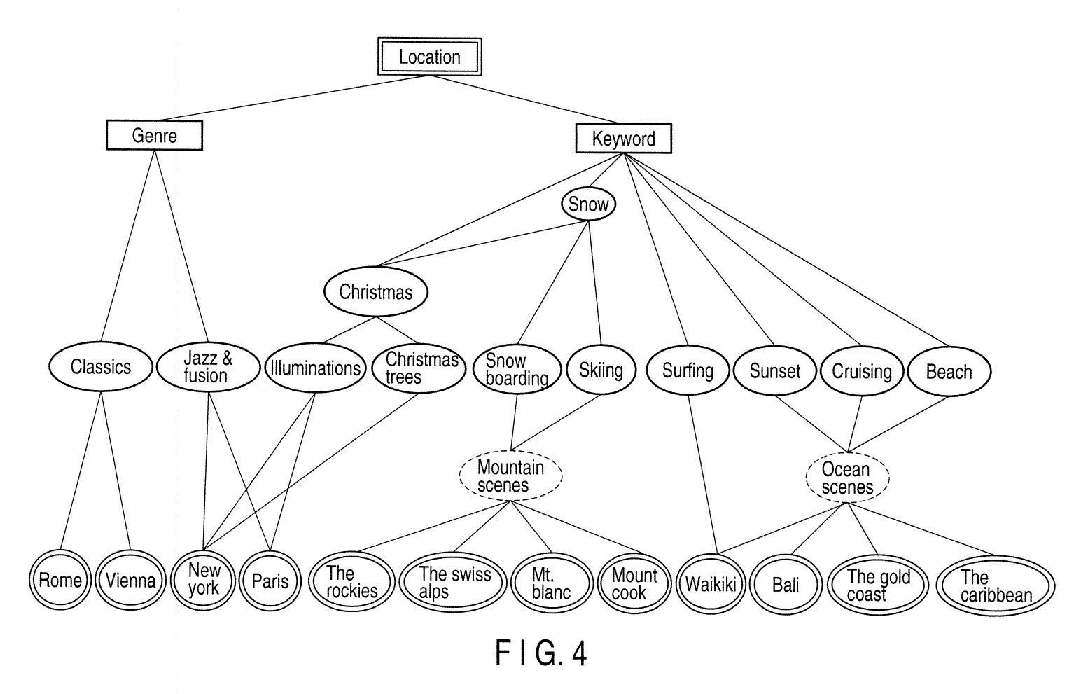

The system data refers to data such as a music data management table (FIG. 2), a live camera management table used by the live camera video control module 22 (FIG. 3), and a conceptual graph used by a retrieval formula generation module 20 (FIG. 4), for example.

The music data management table (FIG. 2) is a table for storing music composition data, such as album names, artist names, and genres that are registered in the publicly-known Gracenote CDDB technology.

The live camera management table (FIG. 3) is a table for storing the counter (Ctn) of each leaf node, which will be described below, the priority order (order) of each live camera, the display time (time) of each live camera, the location (location) in which each live camera is installed, and the URL of each live camera.

The conceptual graph (FIG. 4) defines interrelation between concepts in a graph structure, and is used in the present invention to associate “music genre” and “keyword” with “location (leaf node)”. For example, assuming that “Rockefeller Center Christmas Tree” is generally famous, “Christmas trees” and “New York”, where the Rockefeller Center is located, is linked in the graph structure.

More specifically, the conceptual graph contains a plurality of pieces of destination information (Rome, Vienna, New York, Paris, The Rockies, The Swiss Alps, Mont Blanc, Mount Cook, Waikiki, Bali, etc.) The conceptual graph further contains a plurality of pieces of lexicon classification node information each associated with one or more of the pieces of destination information and indicating the concept of a music composition (snow, Christmas, classics, jazz, illuminations, Christmas trees, snowboarding, skiing, surfing, etc.).

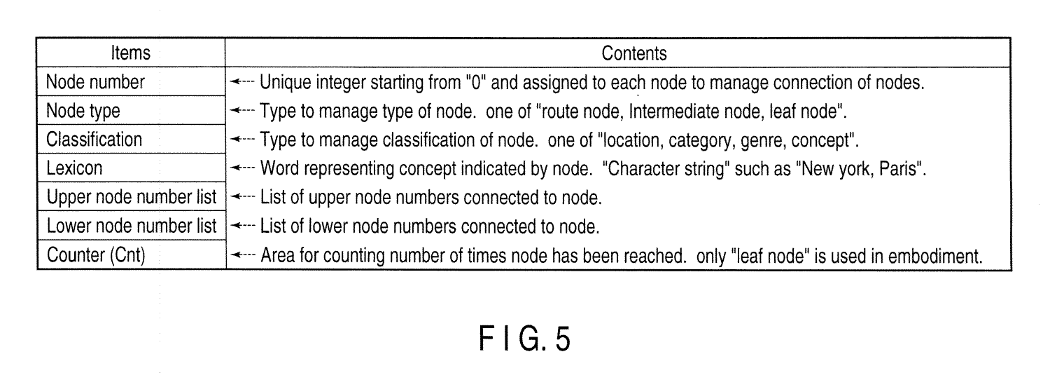

FIG. 5 shows an example of a data structure of a conceptual graph. The counter (Ctn) is, in the present embodiment, effective in leaf nodes, and is used to hold the number of times leaf nodes (destination information) are reached when the conceptual graph of FIG. 4 is followed downward from an intermediate node corresponding to the genre or the keyword. The greater the number of times of the location (leaf node) is, the location is more strongly associated with the music composition being played back, and has a higher priority order in displaying the live camera.

In the present embodiment, a hard disc drive is used as the storage 14, but other storage mediums, such as a solid state drive (SSD), may of course be used.

The communication module 15 is a network adapter for connecting to the Internet. In the present embodiment, connection to the Internet 16 is performed via the communication module 15, and a retrieval engine 17 retrieves live camera videos, and receives streams of live camera videos.

The above-described modules 1-15 correspond to the standard structures of network-compliant digital televisions equipped with a recording function.

The Internet 16 is a computer network in which worldwide networks are mutually connected using the TCP/IP communications protocols.

The retrieval engine 17 is a Web site designed to retrieval for information made public on the Internet by keyword, for example. The retrieval engine 17 is a publicly known technique, broadly known as Google (registered trademark) and Yahoo (registered trademark), for example. In the present embodiment, the retrieval engine 17 is used to retrieve live cameras.

The live camera 18 is a system of transmitting live videos of cameras installed in various locations at home and abroad. There are two types of live cameras: cameras that receive still images every several tens of seconds; and cameras that receive moving images. The later cameras will be used in the present embodiment. For simplification, MPEG will be used as the stream format. Stream data of the live camera 17 transmitted via the Internet is received by the communication module 15, decoded by the MPEG processing module 4, upconverted by the super-resolution processing module 5, and output to the LCD control module 6.

The music playback module 19 decodes music data in MP3 format, for example, stored in the storage 14, and transmits the output to the audio output module 8. The music playback module 19 further comprises a GUI for music playback, and is capable of displaying album names or title names, for example, on the LCD 7 via the LCD control module 6. Selection of the album or title to be played back is performed using the remote 12.

The modules 6-14 and 19 correspond to the standard structures of hard disc audio devices. Thus, the present embodiment is based on the structure in which “network-compliant digital TV equipped with a recording function” and “hard disc audio device” are mixed.

The device of the present invention is particularly characteristic in having the following three structures, which will be described below.

The retrieval formula generation module 20 is a retrieve module for retrieving destination information from a conceptual graph, which will be described below. The retrieval formula generation module 20 obtains the location (destination information that represents the name of place or city such as New York and Paris) in which the live camera to be retrieved is installed, and generates a retrieval formula. The album name and the title name are divided into minimum constituent units using morphological analysis, which is a language processing technique, the key words are translated into Japanese for example, and then a conceptual graph is retrieved.

Thus, the function of the retrieval formula generation module 20 is to retrieve a conceptual graph based on information of a music composition being played back, and generate a retrieval formula for retrieving live cameras in the location corresponding to the music composition.

A meta-retrieval engine module 21 transmits the retrieval formula generated by the retrieval formula generation module 20 to the retrieval engine 17, and obtains the URL of the live camera matching the retrieval formula.

Since a plurality of live camera URLs are usually obtained, the meta-retrieval engine module 21 can also perform a selection process based on conditions. In the present embodiment, the live camera that is presented with the highest relevance ratio by the retrieval engine 17 (i.e., top result) will be selected for simplification. However, live cameras determined by the retrieval will include inactive live cameras, such as cameras that do not operate during certain time periods or have been removed from service at the time of the retrieval. Accordingly, a connection test is performed via the communication module 15, and URLs of active live cameras are set in the “Live camera URL” item in the live camera management table. That is, the present embodiment makes it a selection condition that the live camera has high a relevance ratio and is active.

Since the Internet 16 covers various regions on Earth, videos from live cameras at nighttime may be too dark to see. It is also possible that some live cameras are under maintenance, and videos from such live cameras are useless.

Considering such various kinds of elements, the function of the meta-retrieval engine 21 is to activate the retrieval engine 17 using the retrieval formula and to filter the result returned by the retrieval engine 17.

The live camera video control module 22 has a function of connecting to live cameras, as appropriate, based on the URL of the live camera management table and live camera display conditions (whether to automatically perform switch and how many every minutes the switch is performed), and display the video on the LCD 7. Thus, the function of the live camera video control module 22 is to acquire live camera videos based on the live camera URL of the live camera management table, and to display the videos on the LCD 7 by switching them at a predetermined time interval according to the specification by the user.

Hereinafter, the process of (1) setting the live camera display, (2) playing back a music composition, and (3) displaying a live camera video on the LCD 7 will be described.

(1) Live Camera Display Setting

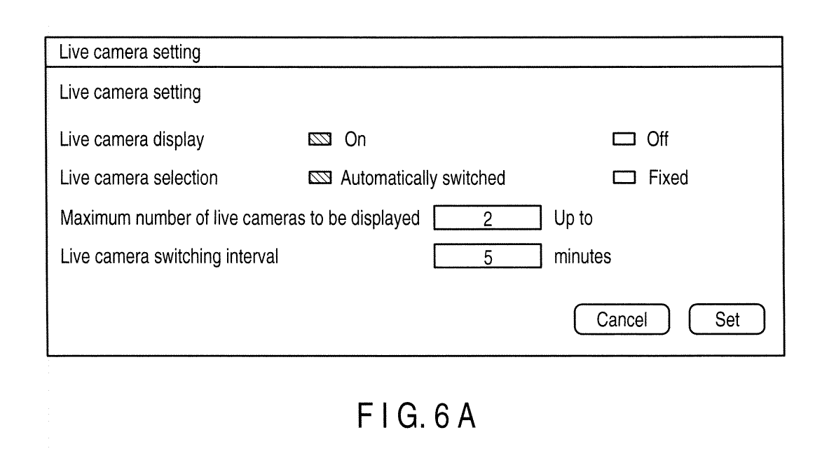

Live camera setting is performed via the remote 12 (FIG. 6B) using a graphical user interface (GUI) (FIG. 6A), as shown in FIG. 6.

When “SET LC” button of the remote 12 is pressed down, “Live camera setting screen” shown in FIG. 6A is displayed on the LCD 7. An item is selected using the D-pad, and a numerical value is input via the numerical pad and confirmed via the SET button.

In the present embodiment, an example is shown in which the SET button is pressed after the live camera display is set “ON”, the live camera selection is set to “Automatic switch”, the maximum number of live camera display is set to “2”, and the live camera switching interval is set to “5” minutes.

The system control module 10 sets the values of the variables of the nonvolatile semiconductor memory region as will be described below.

Variable LiveCameraSW=1 (Whether to display a live camera video during playback of a music composition . . . “0”: NO, “1”: YES)

Variable LiveCameraMODE=1 (“0”: Fixed [only the live camera with the highest priority order will be displayed], “1”: Automatically switched at predetermined intervals)

Variable LiveCameraMax=2 (Integers greater than or equal to “1”. The total number of live cameras to be displayed.)

Variable LiveCameraInterval=5 (time interval of automatic switch [in minutes])

The live camera setting is completed by the above-described process. Since the setting is stored in the nonvolatile memory, this operation needs to be performed only once unless there is a change.

(2) Music Composition Playback

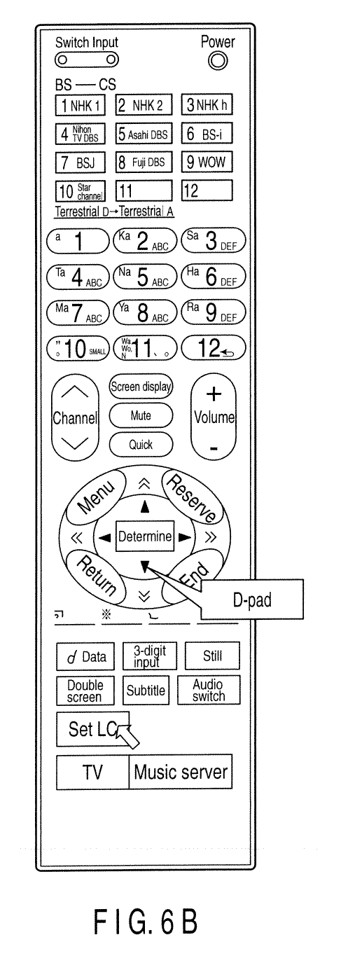

A client TV plays back a music composition by pressing the “MUSIC SERVER” button on the remote 12. When the MUSIC SERVER button is pressed, the system control module 10 displays the “Music composition selection screen” of FIG. 7A on the LCD 7. In the present embodiment, the user selects the music composition title “Snow! Snow! Snow!” of the album title “BC's Christmas Classics” using the D-pad of the remote 12 (FIG. 7B). Next, the playback button “Triangle” (second from the left) on the “Music composition selection screen” is pressed down.

The system control module 10 transmits attribute information “Album No=1, Title No=7” and “Music composition playback command” of the selected music composition to the music playback module 19. The music playback module 19 reads the music composition data from the storage 14 via the HDD control module 13, decodes the music composition data, and transmits the audio output to the audio output module 8. As a result of the above-described operation and process, the music composition “Snow! Snow! Snow!” starts to be played back.

(3) Live Camera Video Display

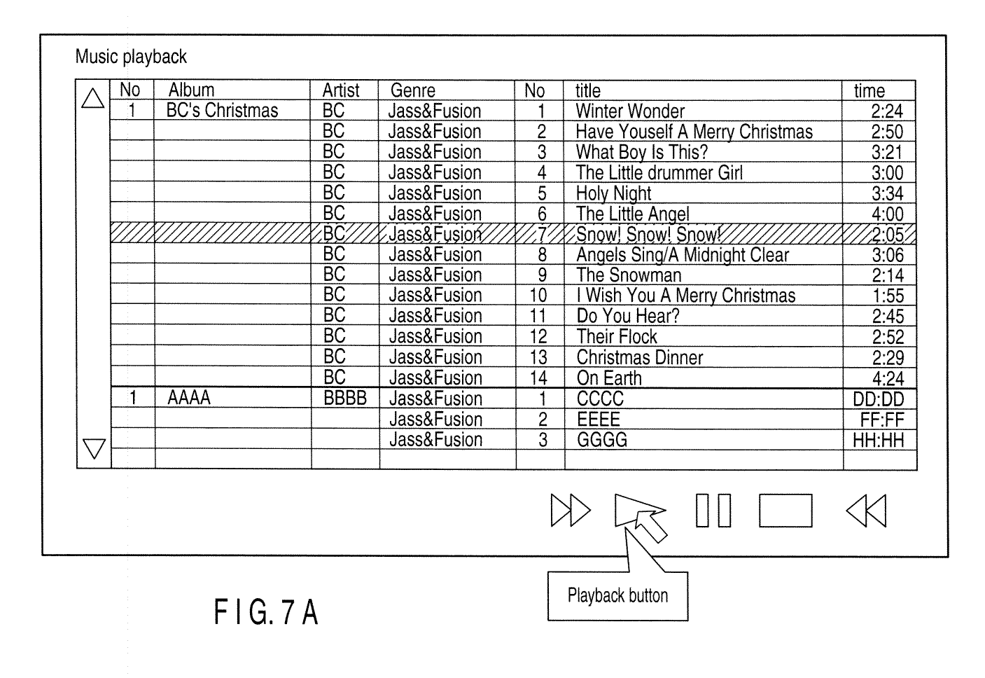

In parallel with issue of the music composition playback command, the system control module 10 checks the variable LiveCameraSW and judges whether to display the live camera image. In the present embodiment, since the variable is set such that the relation LiveCameraSw=1 (live camera video is displayed) is satisfied, “Music selection screen” is closed and the live camera video is displayed. Then, the process of FIG. 8 is started.

(3.1) Retrieval of Conceptual Graph

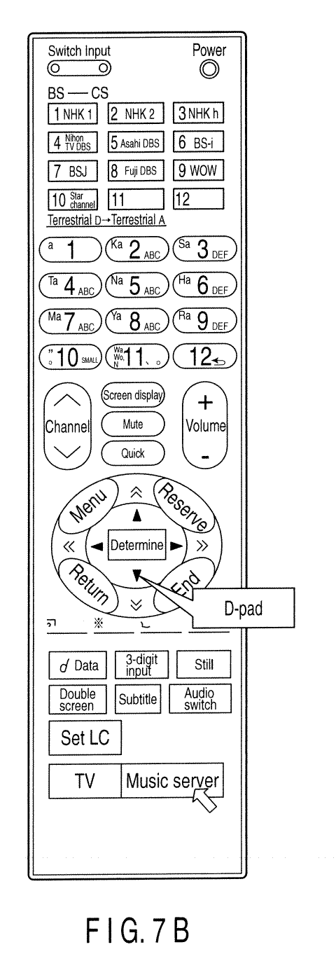

The system control module 10 transmits information “Album No=1, Title No=7” on the music composition being played back. The retrieval formula generation module 20 retrieves a conceptual graph (step S801). Details about retrieval of the conceptual graph will be described with reference to the flowchart shown in FIG. 9. In the descriptions that follow, database of the conceptual graph of FIG. 4 stored in the storage 14 will be used.

First, the music data management table is retrieved based on the information “Album No=1, Title No=7” on the music composition being played back, and the album name “BC's Christmas”, the title name “Snow! Snow! Snow!”, and the music composition genre “Jazz & Fusion” is extracted (steps S901-S904). The next step S905 is performed for check purpose when data on the music composition genre does not exist.

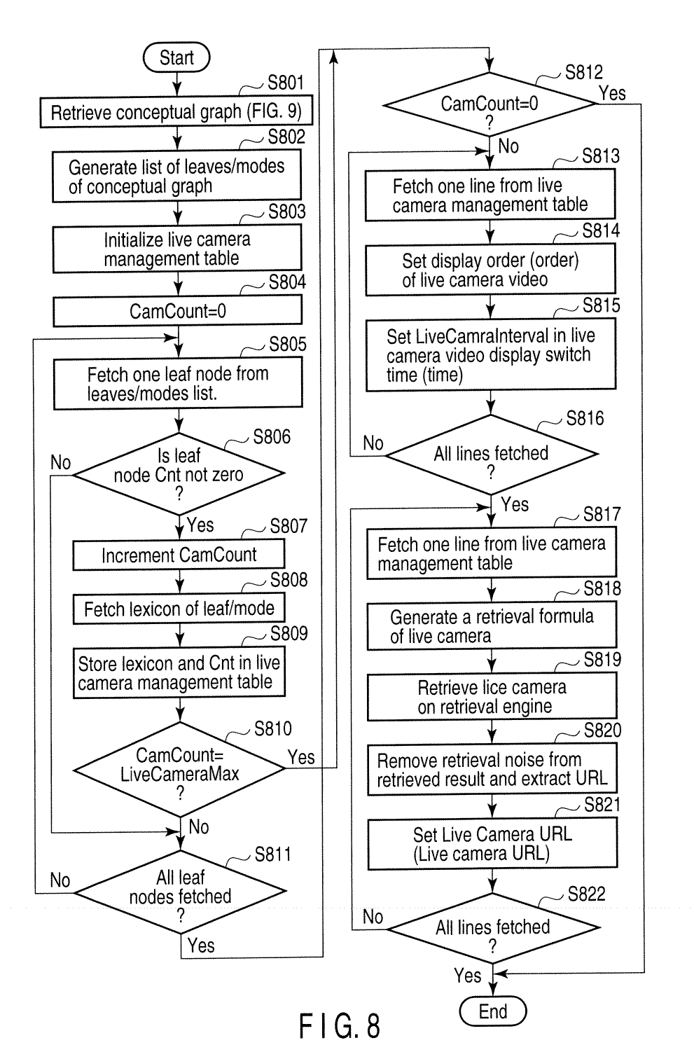

In the present embodiment, since the genre data is acquired, the leaf nodes “New York” and “Paris” are found from the node “Jazz & Fusion” of the conceptual graph, and the counter (Cnt) of this node is incremented (steps S905-S908). The resulting counters of the leaf nodes are shown in FIG. 10.

Second, the keywords “BC's, Christmas” and “Snow, Snow, Snow” are extracted from the album name and the title name, respectively, and are registered in “list”, not shown, using the known language processing technique, morphological analysis.

Thereby, the five keywords {BC's, Christmas, Snow, Snow, Snow} are registered in the list (steps S909 and S910). Since the conceptual graph is predicated on being generated in the Japanese language, the list is converted into the Japanese language here (keyword normalization process). Since only nouns that appear in nodes of the conceptual graph are registered in a dictionary, not shown, which is used in conversion into the Japanese language, proper nouns will be blank characters (“BC's” will be a blank character in the present embodiment). Accordingly, the list converted into the Japanese language becomes “KURISUMASU(Christmas), YUKI(snow), YUKI(snow), YUKI(snow)” (step S911).

Third, “ [symbol] (Christmas)” is extracted from the list (step S912), the corresponding node is found from the conceptual graph, and the leaf nodes are traced. Since the leaf nodes “New York” and “Paris” are reached again, the counters of these nodes are incremented (steps S913 and S914).

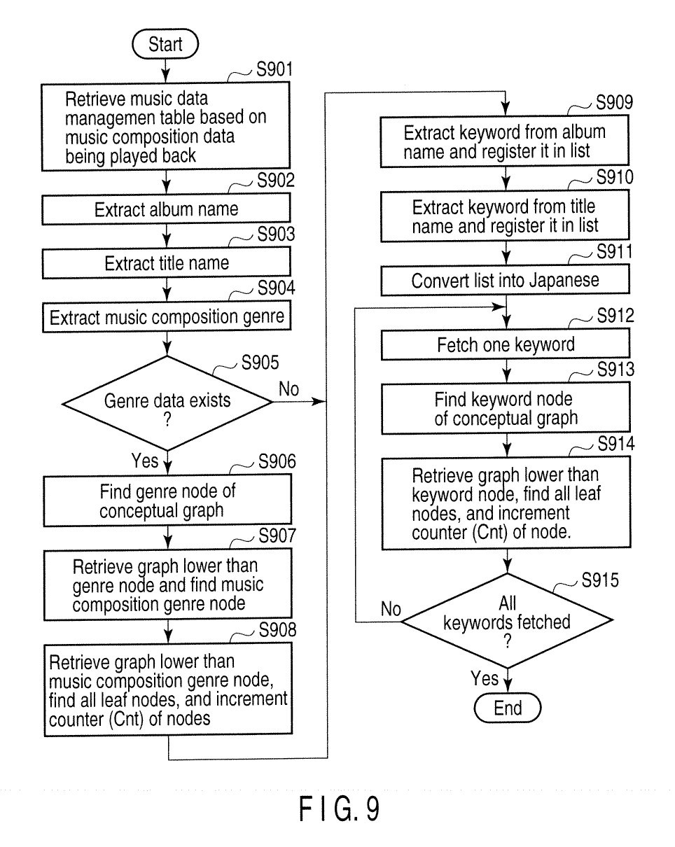

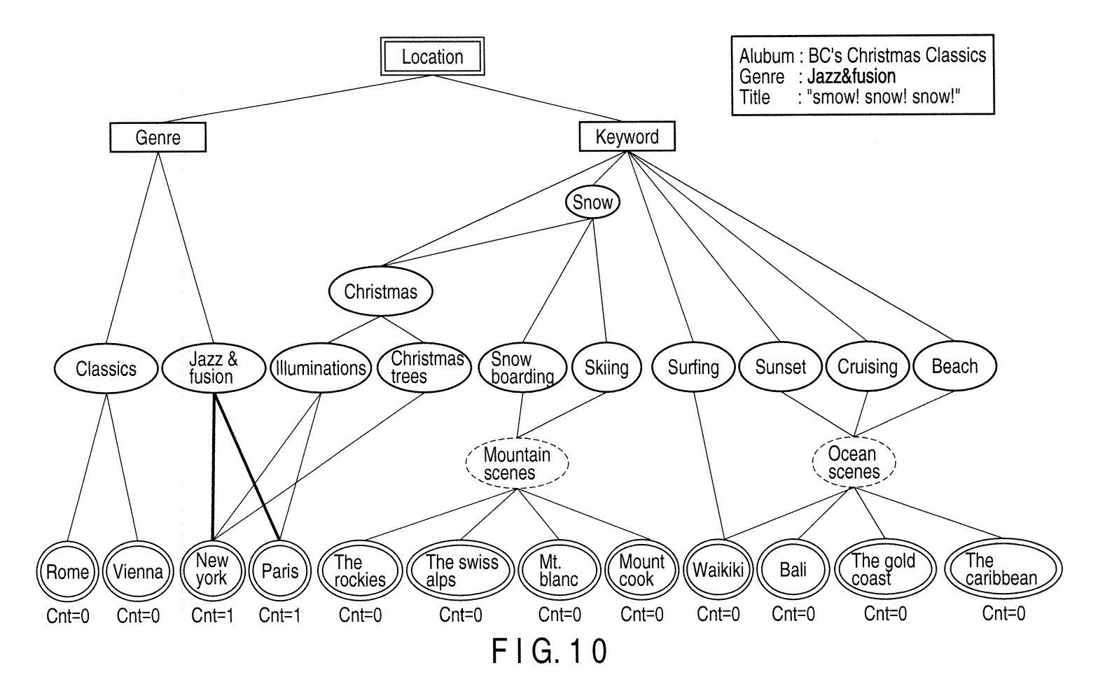

The resulting counters of the leaf nodes are shown in FIG. 11. Since the keywords {YUKI(snow), YUKI(snow), YUKI(snow)} remain in the list (step S915), the remaining keyword “YUKI(snow)” is extracted three times (steps S912-S915). The definitive counters of the leaf nodes are shown in FIG. 12 (New York Cnt=5, Paris Cnt=3).

Thus, the value (weighted value) of the counter (Cnt), which indicates the number of times the leaf node is reached from the intermediate nodes, indicates the strength of relevance between the selected music composition and the specific location. This value is used to determine the order of live camera display in the process that will be described below (to preferentially display live cameras in locations having strong relevance to the music composition). This is the end of the process of step S801.

(3.2) Generation of Live Camera Management Table

Next, the retrieval formula generation module 20 retrieves only the leaf node of the conceptual graph (step S802), and generates a live camera management table in the storage 14, as shown in FIG. 3 (step S803). Further, the retrieval formula generation module 20 retrieves leaf nodes having a counter (Cnt) value other than zero up to the number of the variable LiveCameraMax (2 in the present embodiment), and the counter (Cnt) of the leaf node is set to the counter (Cnt) of the live camera management table, and a lexicon is set in the location (steps S804-S811).

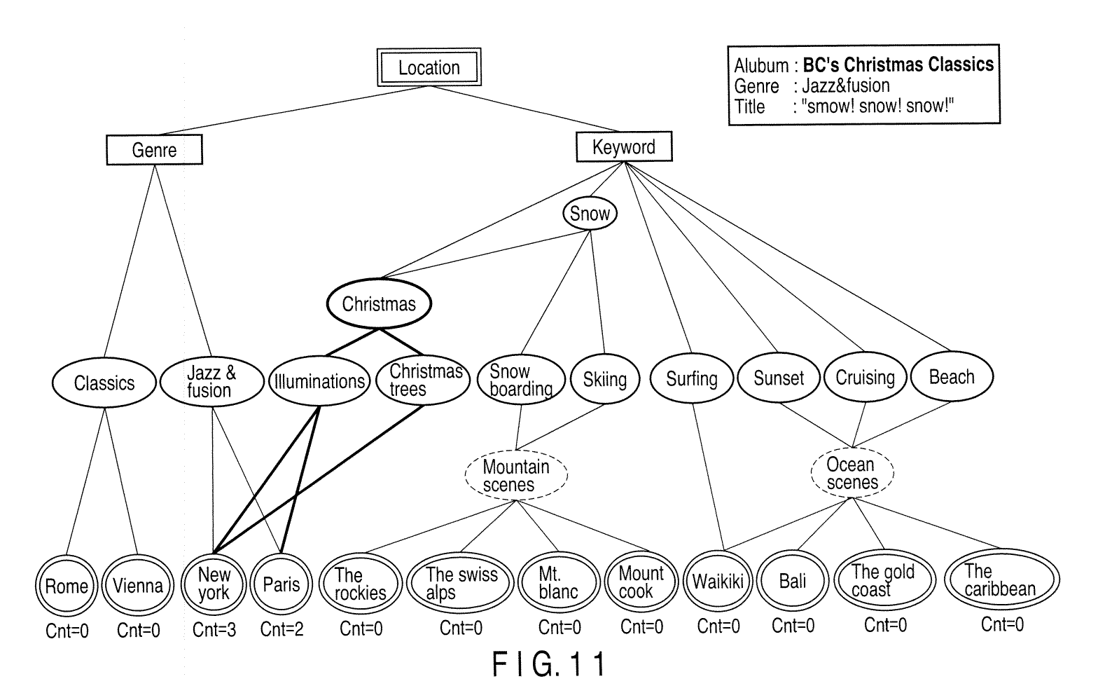

In the present embodiment, since LiveCameraMax is 2, the leaf nodes “New York” and “Paris”, which have counter values other than zero, are retrieved, and the city names are stored in the location of the live camera management table along with the counter values. The live camera management table at this stage is shown in FIG. 13.

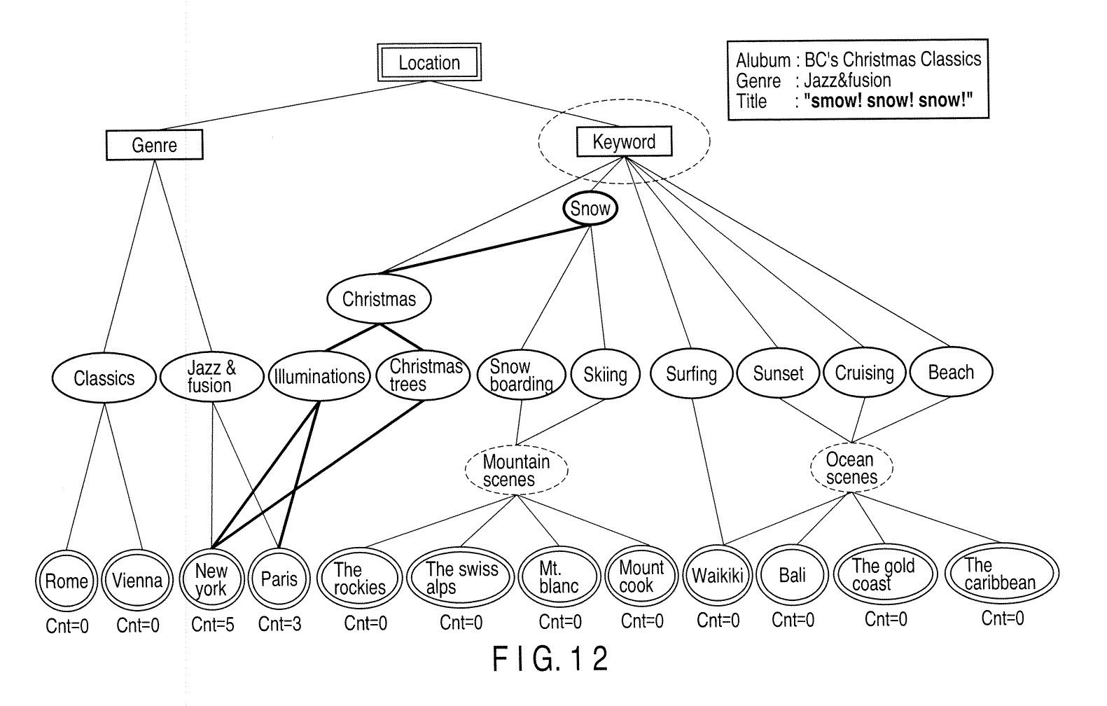

Next, a line in which the lexicon is set in the live camera management table is fetched one by one, and the live camera display order (order), which is determined in descending order of the counter (Cnt), and the display switch time (time), which is the value of the preset variable LiveCameraInterval (=5), are set (steps S813-S816). The resulting live camera management table is shown in FIG. 14.

(3.3) Setting of Live Camera URL in Live Camera Management Table

Next, the retrieval formula generation module 20 retrieves the line in which the lexicon is set in the live camera management table one by one, generates a retrieval formula to retrieve live cameras on the Internet, and performs communications with the retrieval engine 17 via the meta-retrieval engine module 21. The meta-retrieval engine module 21 sets the URL of the live camera in the live camera management table (live camera URL) after removing retrieval noise (which will be described later) (steps S817-S822).

The retrieval formula combines the keyword for retrieving live cameras and the location of the live camera management table. For example, the keyword for retrieving the live camera in Google, which is a broadly known retrieval engine, “inurl:ViewerFrame?Mode=” (Generally, this keyword differs according to the retrieval engine being used). In order to limit the retrieval, the location is added to the retrieval formula, which will be the final retrieval formula. For example, in order to retrieve live cameras in New York, “New York” and “inurl:ViewerFrame?Mode=” are coupled to obtain the retrieval formula “New York inurl:ViewerFrame?Mode=” (Step S818).

The retrieval formula generated by the retrieval formula generation module 20 is passed to the meta-retrieval engine module (21), and the meta-retrieval engine module 21 activates the retrieval engine 17 (step S819). Generally, when retrieval is performed on retrieval engines, unintended retrieval results are mixed. They will be called “retrieval noise”.

In the present invention, the most problematic retrieval noise is caused by existence of the inactive live camera. Accordingly, the meta-retrieval engine module 21 actually connects to candidate URLs to be registered in the live camera management table so as to confirm their operations. (More specifically, the connection is performed so as to confirm whether streaming data can be received). If streaming data can be received, the URL is registered in the item “Live Camera URL (Live camera URL)” of the live camera management table. If streaming data cannot be received, the same operation is performed on the second candidate of the retrieval result so as to find URLs that can receive streaming data.

In the present embodiment, assume that streaming data regarding “New York” and “Paris” can be received by the live cameras with the following URLs:

URL “http://XX.85.XX.104/ViewerFrame?Mode= . . . ”

URL “http://XX.33.XX.138/ViewerFrame?Mode= . . . ”

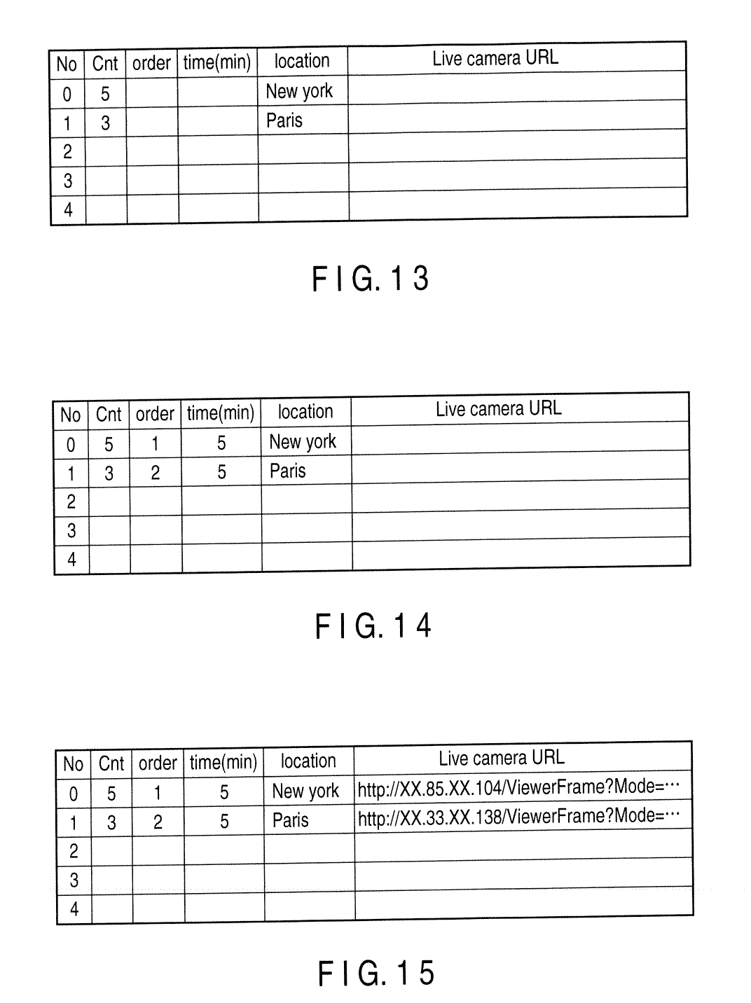

The resulting live camera management table is shown in FIG. 15.

(3.4) Live Camera Video Display

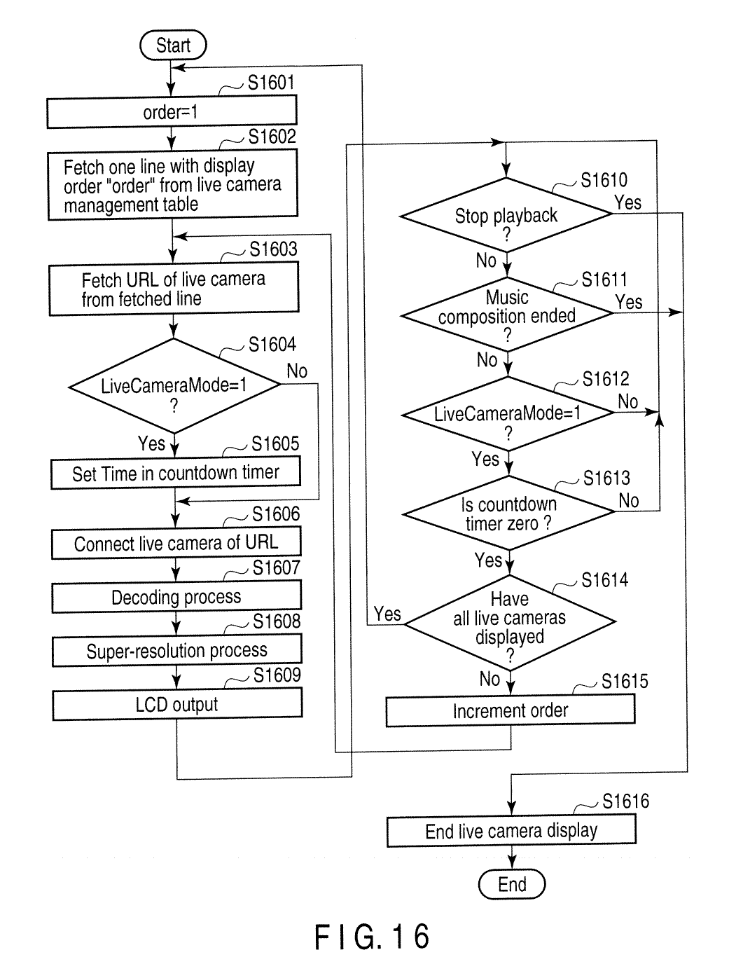

Receiving notification of the end of generation of the live camera management table from the meta-retrieval engine module 21, the live camera video control module 22 starts the process shown in FIG. 16 based on the table shown in FIG. 15, for example.

First, the line with the priority order 1 (order=1) is retrieved, and the registered URL is retrieved (steps S1601-S1603). Next, since the variable LiveCameraMode is 1 (automatically switched), 5 (5 minutes), which is the value of the variable LiveCameraInterval, is set in the countdown timer (steps S1604-S1605).

The URL retrieved in step S1603 will be “http://XX.85.XX.104/ViwerFrame?Mode= . . . ”. This URL is transmitted to the communication module 15, and the system control module 10 notified of start of display of a live camera video. The notified system control module 10 transmits a connection command to connect to the live camera 18 to the communication module 15 (step S1606).

Further, the system control module 10 connects the stream data transmitted from the live camera to the MPEG processing module 4, causes the super-resolution processing module 5 to scale up the decoded result, and transmits it to the LCD control module 6 (steps S1607-S1609). Thereby, the live camera videos with the priority 1 will be displayed on the LCD 7.

When LiveCameraMode is 1 (automatic switch), the live camera video control module 22 activates the countdown timer in parallel with display of the live camera video. When the value of the countdown timer has become 0, the priority order (order) is incremented (step S1615), lines of the live camera management table are retrieved again based on the new priority order (i.e., order=2), the corresponding URL is retrieved, and the same process is repeated (steps S1612-S1615, S1602-S1613).

After display of all the live cameras has finished, the variable “Order” is returned to 1 (step S1601), and display is repeated, beginning from the live camera with the display order 1.

(3.5) End of Display of Live Camera Videos

Receiving a command to stop display of live camera videos, or detecting end of playback of a music composition, the system control module 10 ends the live camera display to end the process (steps S1610-S1611, S1616).

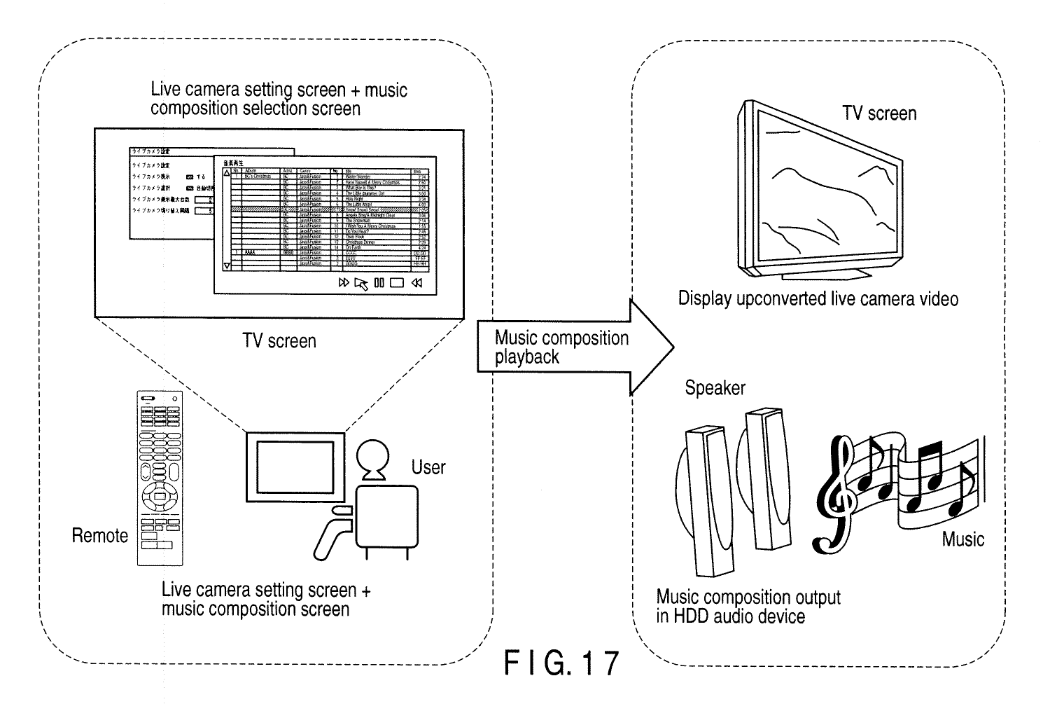

In the above-described process, when a music composition is being played back on a network-type TV equipped with a music server function, live camera videos matching the music can be displayed on the LCD 7. The left side of FIG. 17 shows live camera setting and selection of the music composition to be played back. The right side of FIG. 17 shows the case where the music is actually being played back, and local images from the destination camera are displayed as videos.

In this way, according to the present invention, the user can select live camera videos precisely corresponding to the concept or impressions of the music that is arbitrarily selected by the user, based on its genre or tile, and display them on the TV screen, so as to obtain a relaxation effect. Further, the user will not be bored with the displayed videos, which are from live cameras and change by time, no matter how many hours the user watches them, unlike healing DVDs, for example. Furthermore, since selection of live cameras changes, the music is made unpredictable even if the same music is played back every day.

The present invention is particularly effective in wall-hung large-screen TVs having a screen that could be regarded as a window.

The present invention is not limited to the above-described embodiment and may be embodied with various modifications to the constituent elements within the scope of not departing from the spirit of the invention. Furthermore, the present invention can of course be embodied by combining the embodiments as will be described below.

Although “regions” have not been considered at the time of selection of the live camera in the above-described embodiment, the live cameras may be limited in advance by specifying the regions such as Northern/Southern Hemisphere, North America/Europe, and Japan.

Further, although time differences have not been considered in the above-described embodiment, the storage 14 may be designed to store time zone list data and the meta-retrieval engine module 21 may preferentially select live cameras in regions having a small time difference (specified in advance) from the local time. Further, live cameras having a big time difference may preferentially be selected (by reversing day and night).

Further, although live camera videos have been displayed as they are in the above-described embodiment, live camera videos having a big time difference from the local time may be recorded in advance in an integrated hard disc when the time of such a live camera has become the local time such that they can be used at the time of playback of the next music composition (live camera time shift playback function).

This function exerts its effects when night view (recorded live camera videos) of New York of the previous day is watched while music is played back at dinner time in Japan.

Further, although only “inactive live cameras” have been the retrieval noise to be removed by the meta-retrieval engine module 21 are in the above-described embodiment, “live cameras inappropriate for children to watch” may be removed as the retrieval noise (parental control of live cameras).

Although the conceptual graph has been retrieved by the keywords extracted from the genre, album title, and title name for simplification in the above-described embodiment, keywords obtained by performing morphological, analysis on lyrics may be also added for retrieval such that precision of the live camera selection is improved.

Although the conceptual graph has been retrieved by the attributes of the music composition, such as the keywords of the genre, album title, and title name, the conceptual graph may be retrieved based on the music composition structure and the result of rhythm analysis. In this case, the patterns of popular music, samba music, and the like are detected, and these classifications are used to retrieve the conceptual graph. Since the characteristic amount extracted directly from the music composition is used, effects are exerted when the genre is unknown and keywords cannot be extracted from the album name or the title name.

Although the conceptual graph regarding “location” has been used in the above-described embodiment, other conceptual graphs (e.g., a conceptual graph regarding “scene” such as “night view”) may be used, and more than one conceptual graphs may be combined.

Although “location” has been determined based on the conceptual graph stored in advance, the conceptual graph may be designed such that the user can define or add/modify the conceptual graph. In this case, the add/modify mode of the conceptual graph is executed. Thereby, the tree graph shown in FIG. 4 and the data-structure table shown in FIG. 5 will be displayed in the LCD. The user can specify the node of the tree graph, display the data structure table, and modify it. In order to set a new node, when a cursor is moved to the spacer module of the node shown in FIG. 4 and the “determine” button is pressed, the table shown in FIG. 5 appears. On the table of FIG. 5, the lexicon, the upper node number, the lower node number, the classification, and the node type are input. The node number is automatically assigned.

Although “location” has been determined based on the conceptual graph stored in advance in the above-described embodiment, the conceptual graph may be designed to be downloaded from an external server based on control of the operation module 11 and the control module 10. Further, the user may improve and upload the conceptual graph so as to provide other users with it.

Although the “TV side” comprises the modules “the retrieval formula generation module, the meta-retrieval engine module, and the live camera video control modules” and “data used by each module” in the above-described embodiment, an external server may be provided, for example, so as to comprise these modules. That is, in the above-described embodiment, data files of the music data management table (FIG. 2) and the conceptual graph (FIG. 4) have been described as being stored in the storage 14. However, the music data management table and the conceptual graph may be managed by an external server, as well as this location. When the music data management table and the conceptual graph are in an external server, the title name of the music composition selected by the user is transmitted to the server. The retrieval formula generation module and the meta-retrieval engine module provided on the external server perform retrieval, and transmits URLs of live cameras associated with the selected music composition.

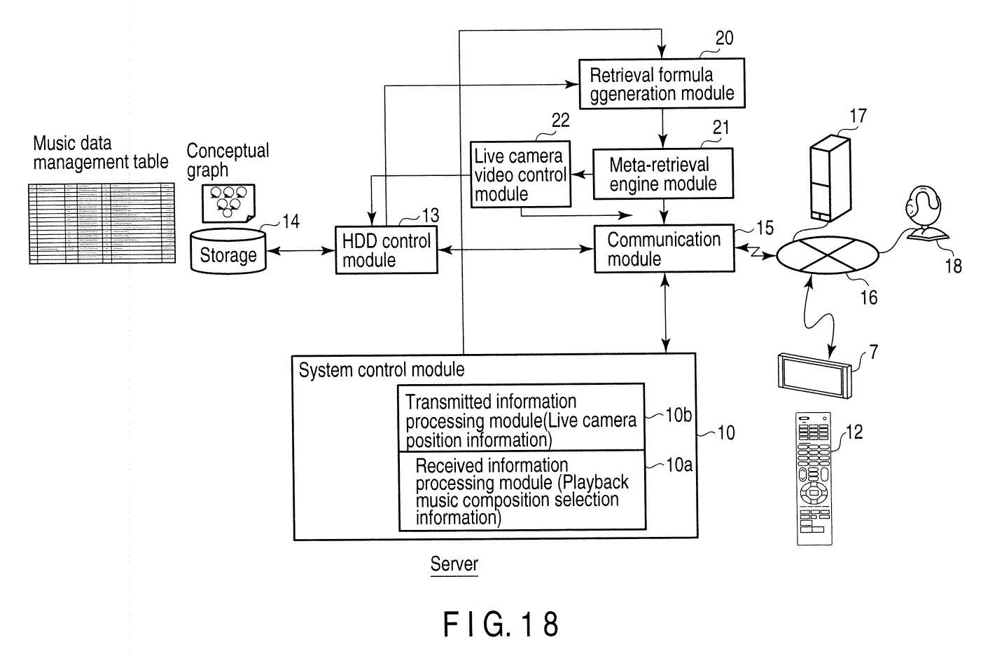

FIG. 18 shows an example in which the retrieval formula generation module 20, the meta-retrieval engine module 21, and the live camera video control module 22 are provided at the server side. The elements corresponding to those of FIG. 1 are denoted by the same reference numerals. In this server, the data file 14 stores data of a conceptual graph containing a plurality of destination information items each indicating a video providing region and a plurality of lexicon classification node information items associated with one or more of the destination information items and indicating the concept of the music composition. Further, the reception information processing module 10a may receive information on the music composition to be played back via the network 16 from an external client (TV). The retrieval formula generation module 20 retrieves the lexicon classification node information similar to or same as the music concept information indicating the concept of the music composition from the lexicon node information items, extracts hit destination information corresponding to the retrieved lexicon classification node information from the destination information items, the music composition concept information is changed, the retrieval is executed a plurality of times, and one or more hit destination information items having a strong relationship with the selected music composition are acquired.

The meta-retrieval engine module 21 acquires camera position information corresponding to one or more hit destination information items via the communication module 15. The transmission information processing module 10b transmits the camera arrangement information to the client TV. The operation of acquiring camera arrangement information is the same as the operation described in the above-described embodiment. The data of the conceptual graph may have been improved and uploaded by the client. Further, the conceptual graph improved by a plurality of users may be managed by the server side such that conceptual graph data improved by a plurality of servers is automatically epitomized. By applying the collective intelligence to the conceptual graph data, precision of the conceptual graph data can further be enhanced.

The conventional techniques involved the problem that videos to be combined with music are uniformed and make the user bored when viewed repeatedly. Further, some music does not have content combined with videos.

The present invention has been made in consideration of the above-described problems, and provides means and device for obtaining healing effects and unpredictability by selecting/displaying live camera videos corresponding to the genre or title of the music that is arbitrarily selected by the user from the Internet.

The present invention is effective in processing music concept data in a server, a set top box, a television (TV) receiver, a compact video display device, and a recording device.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope of spirit of the inventions.

What is claimed is:

1. A video display device, comprising:
a data file configured to store a conceptual graph that includes a plurality pieces of destination information and a plurality of pieces of lexicon classification node information, the destination information indicating a region where a video is provided, the lexicon classification node information indicating a concept of a music composition and being associated with one or more of said plurality of pieces of destination information;
a retrieval module configured to
(a) retrieve, upon receipt of information on a music composition to be played back, lexicon classification node information similar to or same as music composition concept information indicating a concept of the received music composition from said plurality of pieces of lexicon classification node information,
(b) extract hit destination information corresponding to the retrieved lexicon classification node information from said plurality of pieces of destination information,
(c) execute the retrieval a plurality of times by changing the music composition conceptual information, and
(d) retrieve one or more pieces of hit destination information strongly associated with the selected music composition; and
a retrieval and communication module configured to acquire camera position information corresponding to said one or more pieces of hit destination information.

2. The video display device of claim 1, wherein the music composition concept information stored in the data file is one, a combination, or all of a genre, an album name, and a title name of a music composition, and said plurality of pieces of lexicon classification node information is a plurality of lexicons indicating the genre, the album name, and the tile name.

3. The video display device of claim 1, wherein the retrieval and communication module is configured to remove position information of an inactive camera from the acquired camera position information, and set position information of the other live cameras in a live camera management table.

4. The video display device of claim 3, further comprising a control module configured to perform system settings including specification of whether to switch live camera videos captured based on said plurality of pieces of camera position information and automatic switching interval of live camera videos.

5. The video display device of claim 3, wherein the live camera video captured based on said plurality of pieces of camera position information is stored in a recording medium in advance and is played back based on control of the live camera video control module when camera position information corresponding to the next time is captured.

6. The video display device of claim 1, wherein data on the conceptual graph is data downloaded from an external server.

7. The video display device of claim 1, wherein data on the conceptual graph can be added or modified by an operation input.

8. A data processing server, comprising:
a data file configured to store data on a conceptual graph that includes a plurality pieces of destination information and a plurality of pieces of lexicon classification node information, the destination information indicating a region where a video is provided, the lexicon classification node information indicating a concept of a music composition and being associated with one or more of said plurality of pieces of destination information;
a received information processing module configured to receive information on a music composition to be played back from an external client;
a retrieving module configured to
(i) retrieve lexicon classification node information similar to or same as music composition concept information indicating a concept of the received music composition from said plurality of pieces of lexicon classification node information,
(ii) extract hit destination information corresponding to the retrieved lexicon classification node information from said plurality of pieces of destination information,
(iii) execute the retrieve a plurality of times by changing the music composition conceptual information, and
(iv) retrieve one or more pieces of hit destination information strongly associated with the selected music composition;
a retrieval and communication module configured to acquire corresponding camera position information using said one or more pieces of hit destination information; and
a transmitted information processing module configured to transmit the camera position information to the client.

9. The data processing server of claim 8, wherein the data on the conceptual graph has been improved and uploaded by the client side.

10. A data processing method using a data file and a retrieval module, wherein
the data file stores data on a conceptual graph that includes a plurality pieces of destination information and a plurality of pieces of lexicon classification node information, the destination information indicating a region where a video is provided, the lexicon classification node information indicating a concept of a music composition and being associated with one or more of said plurality of pieces of destination information, and
the retrieval module is configured to
(a) retrieve lexicon classification node information similar to or same as music composition concept information indicating a concept of the received music composition from said plurality of pieces of lexicon classification node information,
(b) extract hit destination information corresponding to the retrieved lexicon classification node information from said plurality of pieces of destination information,
(c) execute the retrieval a plurality of times by changing the music composition conceptual information and acquire one or more pieces of hit destination information strongly associated with the selected music composition; and
(d) output said one or more pieces of hit destination information so as to be used for acquisition of a video of a corresponding destination.
